(19) United States
(12) Patent Application Publication
(10) Pub. No.: US 2007/0274397 A1
(43) Pub. Date: Nov. 29, 2007

(54) Algorithm for Reducing Artifacts in Decoded Video

(75) Inventors: Tatiana G. Kwaaitaal-Spassova, Eindhoven (NL); Olukayode A. Ojo, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 11/578,757

(22) PCT Filed: May 16, 2005
(86) PCT No.: PCT/IB05/51586

§ 371 Date: Oct. 18, 2006

Related U.S. Application Data
(60) Provisional application No. 60/572,211, filed on May 18, 2004.

(51) Int. Cl. H04N 7/26

(52) U.S. Cl. 375/240.24; 375/E07.075

(57) ABSTRACT

The present invention is directed to a method of processing a video signal. The method includes the video signal being split into a low frequency signal and a high frequency signal. The low frequency signal being processed to reduce ringing artifacts. The high frequency signal being processed to reduce blocking artifacts. Further, the low frequency signal and high frequency signal being combined.

The present invention relates generally to video processing, and more particularly, to an algorithm for reducing both block artifacts and ringing artifacts in decoded video.

Digital video compression exploits spatial and temporal correlation or redundancy in image data to reduce the amount of data required to represent video signals. In lossless compression, after decoding, the compressed data is identical to the uncompressed data. In that case, the quality is fixed and the amount of data required to transmit the compressed information will vary.

In most consumer applications (e.g. DVD, digital broadcast, etc,) the average bit rate is fixed. Hence, the quality will vary depending on the complexity of the video sequence. This is an example of the “lossy” encoding schemes. Such exhibit varying degrees of image degradation or artifacts depending on the fidelity of the encoding scheme. Such artifacts include blocking, ringing, and mosquito noise.

Blocking artifacts result from the image being divided into blocks of 8 lines by 8 pixels prior to encoding. Since the blocks are encoded individually, a coarse quantization utilized to reduce the bit rate will lead to the visibility of the block structure. As a result, a significant part of the image is lost.

The reduction of coding artifacts is important for image enhancement. Algorithms do exist that reduce such artifacts. Algorithms that reduce blocking artifacts generally depend on the ability to first detect the edges of the blocks and then measure the degree of blockiness. This is done by looking at discontinuities occurring at the edges of the blocks, for which purpose the grid size and position have to be known.

However, existing algorithms have their limitations. For example, any geometrical transformation of the image after decoding (e.g. scaling) will make it difficult to retrieve the exact block structure. Also, an algorithm that reduces blocking artifacts does not, in general, reduce other artifacts, especially ringing. Hence it is advantageous to find an algorithm that can reduce both blocking and ringing artifacts.

In view of the above, the present invention is directed to a method of processing a video signal. In one example, the method includes the video signal being split into a low frequency signal and a high frequency signal. The low frequency signal is processed to reduce ringing artifacts. The low frequency processing may include low pass filtering or another suitable technique. The high frequency signal is processed to reduce blocking artifacts. The high frequency processing may include median filtering, low pass filtering, temporal low pass filtering, spatial low pass filtering or another suitable technique. Further, the low frequency signal and high frequency signal are then combined to form an output signal.

In another example, the method further includes a flat area being detected in the video signal. In this example, the high and low frequency processing only is enabled for the flat area detected.

In one example, a flat area is detected by a number of steps. Such steps include a reference pixel and a predetermined number of neighboring pixels being selected. The difference between values of the reference pixel and each of the neighboring pixels is calculated. The difference between the values of the reference pixel and each of the neighboring pixels is summed producing a pixel sum. The pixel sum is divided by the predetermined number of neighboring pixels producing a pixel average. Further, the pixel average is then compared to a predetermined number.

Referring now to the drawings where like reference numbers represent corresponding parts throughout:

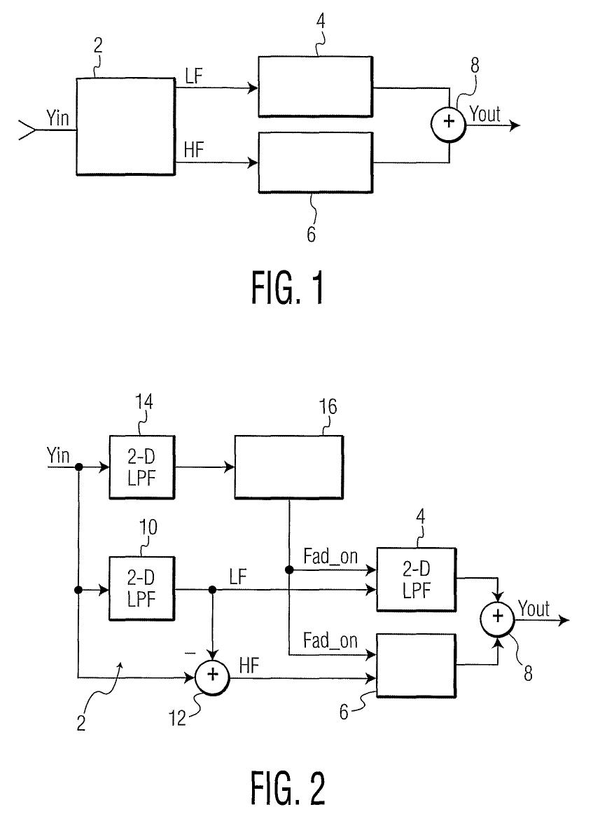

FIG. 1 is a diagram showing one example of an algorithm according to the present invention;

FIG. 2 is a diagram showing another example of an algorithm according to the present invention;

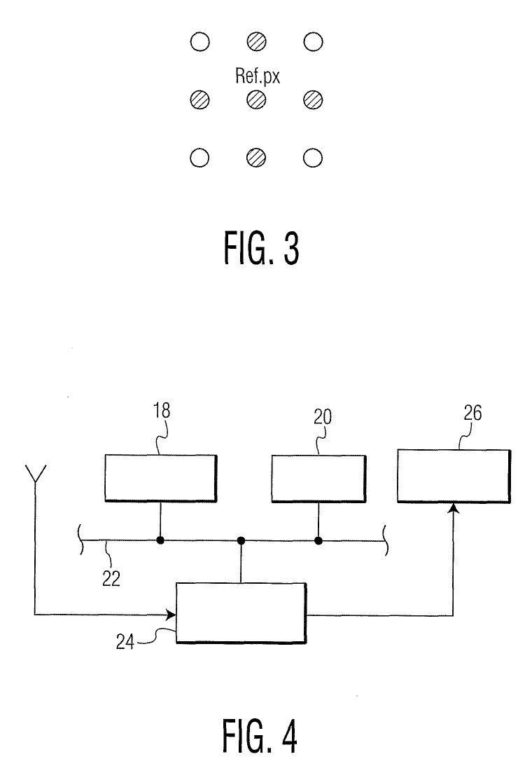

FIG. 3 is a diagram illustrating one example of detecting flat areas according to the present invention; and

FIG. 4 is a diagram showing one example of a device according to the present invention.

The present invention is directed to an algorithm that reduces both block artifacts and ringing artifacts in decoded video. As previously described, algorithms do exist that reduce coding artifacts. However, these existing algorithms have limitations. For example, an algorithm that reduces blocking artifacts does not, in general, reduce other artifacts such as ringing.

One example of the algorithm according to the present invention is shown in FIG. 1. It should be noted that the present invention is intended to be used in conjunction with any block based coding scheme. Thus, the input signal Yin is a video signal that has been decoded by any block based coding scheme such as JPEG, MPEG-1, MPEG-2, MPEG-4 or H.264.

As can be seen from FIG. 1, the input signal Yin is input into a band-splitter 2. The band-splitter 2 will divide the input signal into a low frequency signal and a high frequency signal so that these signals may be separately processed. The present invention is not limited to any specific frequency range for the low and high frequency signals. However, for a standard definition (SD) signal of 5 MHZ, anything below 2 MHZ could be in the low frequency signal and anything above 2 MHZ could be in the high frequency signal. For a high definition signal of 10-20 MHZ, anything below 5 MHZ could be in the low frequency signal and anything above 5 MHZ could be in the high frequency signal.

The outputs of the band-splitter 2 are provided to a low frequency processor 4 and a high frequency processor 6. During operation, the low frequency processor 4 processes the low frequency signal in order to reduce ringing artifacts. Further, the high frequency processor 6 processes the high frequency signal to reduce blocking artifacts. The low frequency processor 4 may be embodied by a low pass filter or any other suitable technique. The high frequency processor 6 may be embodied by a median filter, low pass filter, temporal low pass filter, spatial low pass filter or any other suitable technique.

As can be further seen, the outputs of the low and high frequency processors 4,6 are provided to an adder 8. The adder 8 combines the low and high frequency signals that were previously separately processed into an output video signal Yout. Further, the adder 8 will also limit the values of the output signal Yout. If the input signal Yin had eight-bit values, the output signal Yout would be limited to a value of 0-255. If the input signal Yin had nine-bit values, the output signal Yout would be limited to a value of 0-511. If the input signal Yin had ten-bit values, the output signal Yout would be limited to a value of 0-1023.

Another example of the algorithm according to the present invention is shown in FIG. 2. As can be seen, in this example, the band-splitter 2 is implemented by a 2-D low pass filter and an adder 12. As previously described, the band-splitter 2 divides the input signal into a low frequency signal and a high frequency signal so that these signals may be separately processed.

During operation, the low pass filter 10 will filter the input signal Yin to produce the low frequency signal. The adder 12 than adds the negative value of the low frequency signal to the input signal Yin to produce the high frequency signal. The low pass filter 10 may be implemented by a nine tap 2-D filter with filter coefficients of 1/16, 1/16, 1/16, 1/16, ½, 1/16, 1/16, 1/16 and 1/16.

In another example, the band splitter 2 may be implemented by a 2D-high pass filter instead of the low pass filter. In this example, the high pass filter will produce the high frequency signal from the input signal and the low frequency signal will be produced by subtracting the high frequency signal from the input signal.

Referring back to FIG. 2, in this example, the low frequency processor 4 is implemented by a 2-D low pass filter. As previously described, the low frequency processor 4 processes the low frequency signal in order to reduce ringing artifacts. Thus, during operation, the low pass filter 4 will filter the low frequency signal in order to reduce ringing artifacts. The low pass filter 4 may be implemented by a nine tap 2-D filter with filter coefficients of 1/16, ⅛, 1/16, ⅛, ¼, ⅛, 1/16, ⅛ and 1/16. However, if the degree of ringing in the input signal could be determined or known, it would be possible to use different filters for a different degrees of ringing. For example, a nine tap 2-D filter with filter coefficients of 1/16, 1/16, 1/16, 1/16, ½, 1/16, 1/16, 1/16 and 1/16 may be used if the degree of ringing is small.

In this example, the high frequency processor 6 is implemented by a median filter. As previously described, the high frequency processor 6 processes the high frequency signal to reduce blocking artifacts. Thus, during operation, the median filter 6 will process the high frequency in order to reduce the blocking artifacts.

The median filter processing consists of looking at pixels in both the horizontal and vertical direction and picking the pixels with the middle value. In a three tap median filter, a reference pixel and two neighboring pixels are ranked and the reference pixel takes the value that is in the middle. For example, if the reference pixel has a value of 96 and the neighboring pixels have a value of 122 and 133, the value of the reference pixel will be changed to 122 since it is in the middle. This is done in both the horizontal and vertical direction.

In the example of FIG. 2, both the low pass filter 4 and median filter 6 do not process all of the pixels in the input video. Instead, only pixels that are associated with flat areas will be processed. This is because in flat areas there is less detail. Thus, the occurrence of such artifacts would be more annoying. Therefore, in this embodiment, a flat area detector 16 is included to selectively enable the low pass filter 4 and median filter 6 to only process pixels associated with flat areas.

As can be seen, another low pass filter 14 is included to filter the input signal Yin. The low pass filter 14 removes any noise or disturbances before the input signal reaches the flat area detector 16. The low pass filter 4 may be implemented by a nine tap 2-D filter with filter coefficients of 1/16, ⅛, 1/16, ⅛, ¼, ⅛, 1/16, ⅛ and 1/16.

As previously described, the flat area detector 16 detects flat areas in the input signal Yin. A flat area corresponds to an area where the difference between neighboring pixels is low. During operation, if a flat area is detected, the flat area detector 16 will provide an enabling signal (Fad_on) in order to enable the low pass filter 4 and median filter 6. Thus, the low pass filter 4 and median filter 6 will process the pixels associated with the flat area detected. If a flat area is not detected, the low pass filter 4 and median filter 6 will not be enabled. Therefore, the low and high frequency signals will just be passed through unchanged.

In order to detect a flat area, areas in input video are found where the difference between the neighboring pixels is low. One example of how do detect a flat area is shown in FIG. 3. As can be seen, a reference pixel and four neighboring pixels are chosen. The difference or deviation of each pixel value with respect to the reference pixel value is calculated, as follows:
Devᵢ=|Rpix−Pixᵢ| for i ε [0, 3] (1)

The sum of all deviations is calculated, as follows:

$$SumDev = {\sum }_{i = 0}^{3} Devi \qquad ( 2 )$$

The average of the deviations is then calculated, as follows:
AvSumDev=SumDev/4 (3)

The average of the deviations AvSumDev is a value that represents the probability an area is a flat area. The AvSumDev is then compared to a threshold. If the AvSumDev is below the threshold, then it is a flat area. If the AvSumDev is above the threshold, then it is not a flat area. In one example, the value six (6) was used as a threshold. However, if a noise estimator is available, the output of the noise estimator to control this threshold.

One example of a device according to the present invention is shown in FIG. 4. By way of example, the device may represent a television, a set-top box, a personal computer, a printer or an optical recording device such as a digital video recorder or a DVD as well as portions or combinations of these and other devices. The device includes a processor 18, a memory 20, a bus 22 and one or more input/output devices 24. In case of the device being a television or a computer, it would also include a display 26.

The input/output devices 24, processor 18 and memory 20 communicate over the bus 22. The input video signal input signal is processed in accordance with one or more software programs stored in memory 20 and executed by processor 18 in order to generate an output video signal. This output video signal can be shown on the display device 26.

In particular, the software programs stored in the memory 14 may include a decoder. As previously mentioned, any block based coding scheme may be used. Therefore, the decoder stored in memory may be a JPEG, MPEG-1, MPEG-2, MPEG-4, H.261, H.263 or H.264 decoder.

Further, the software programs in the memory 20 would also include the algorithm that reduces both block artifacts and ringing artifacts as previously described and shown in FIG. 1 or 2. In this embodiment, these algorithms are implemented by computer readable code stored in the memory 20 and executed by the processor 18. In other embodiments, hardware circuitry may be used in place of, or in combination with, software instructions to implement the invention.

While the present invention has been described above in terms of specific examples, it is to be understood that the invention is not intended to be confined or limited to the examples disclosed herein. Therefore, the present invention is intended to cover various structures and modifications thereof included within the spirit and scope of the appended claims.

1. A method of processing a video signal, comprising the steps of:
splitting the video signal into a low frequency signal and a high frequency signal (2);
processing the low frequency signal to reduce ringing artifacts (4);
processing the high frequency signal to reduce blocking artefacts (6); and
combining the low frequency signal and the high frequency signal (8).

2. The method of claim 1, wherein processing the low frequency signal includes low pass filtering.

3. The method of claim 1, wherein processing the high frequency signal is selected from a group consisting of median filtering, low pass filtering, temporal low pass filtering and spatial low pass filtering.

4. The method of claim 1, which further includes detecting a flat area in the video signal.

5. The method of claim 1, which further includes enabling the low frequency processing only for the flat area detected.

6. The method of claim 1, which further includes enabling the high frequency processing only for the flat area detected.

7. The method of claim 4, wherein detecting a flat area, comprises the steps of:
selecting a reference pixel and a predetermined number of neighboring pixels;
calculating the difference between values of the reference pixel and each of the neighboring pixels;
summing the difference between the values of the reference pixel and each of the neighboring pixels producing a pixel sum;
dividing the pixel sum by the predetermined number of neighboring pixels producing a pixel average; and
comparing the pixel average to a predetermined number.

8. A device for processing a video signal, comprising:
means for splitting the video signal into a low frequency signal and a high frequency signal (2);
means for processing the low frequency signal to reduce ringing artifacts (4);
means for processing the high frequency signal to reduce blocking artefacts (6); and
means for combining the low frequency signal and high frequency signal (8).

9. The device of claim 8, wherein the means for processing the low frequency signal is a low pass filter.

10. The device of claim 8, wherein the means for processing the high frequency signal is selected from a group consisting of median filter, low pass filter, temporal low pass filter and spatial low pass filter.

11. The device of claim 8, which further includes means for detecting a flat area in the video signal.

12. The device of claim 11, which further includes means for enabling the processing the low frequency signal only for the flat area detected.

13. The device of claim 11, which further includes means for enabling the processing the high frequency signal only for the flat area detected.

14. A memory medium including code for processing a video signal, the code comprising:
a code for splitting the video signal into a low frequency signal and a high frequency signal;
a code for processing the low frequency signal to reduce ringing artifacts;
a code for processing the high frequency signal to reduce blocking artifacts; and
a code for combining the low frequency signal and the high frequency signal.

15. The memory medium of claim 14, which further includes a code for detecting a flat area in the video signal.

16. The memory medium of claim 15, which further includes a code for enabling the processing the low frequency signal only for the flat area detected.

17. The memory medium of claim 15, which further includes a code for enabling the processing the high frequency signal only for the flat area detected.

18. The memory medium of claim 15, wherein the code for detecting a flat area includes:
a code for selecting a reference pixel and a predetermined number of neighboring pixels;
a code for calculating the difference between values of the reference pixel and each of the neighboring pixels;
a code for summing the difference between the values of the reference pixel and each of the neighboring pixels producing a pixel sum;
a code for dividing the pixel sum by the predetermined number of neighboring pixels producing a pixel average; and
a code for comparing the pixel average to a predetermined number.
